(19) United States
(12) Patent Application Publication
(10) Pub. No.: US 2005/0051570 A1
(43) Pub. Date: Mar. 10, 2005

(54) Method for improving the operational reliabilty of dosing devices

(76) Inventors: Oliver Wendt, Hamburg (DE); Christine Rohr, Hamburg (DE); Marco Kuhn, Hamburg (DE)

Correspondence Address: GRIFFIN & SZIPL, PC, SUITE PH-1, 2300 NINTH STREET, SOUTH, ARLINGTON, VA, 22204, US

(21) Appl. No.: 10/475,958

(22) PCT Filed: Apr. 25, 2002
(86) PCT No.: PCT/EP02/04560

(30) Foreign Application Priority Data
Apr. 27, 2001 (DE) 101 20 756.5

(51) Int. Cl. G01F 11/00

(52) U.S. Cl. 222/1

(57) ABSTRACT

The dispensing of sample liquids is performed, particularly in case of high-throughput screening, by means of automatic dosing devices. Between individual dosing processes, the standstill of the dosing device may lead to an outgassing of the sample liquid existing in the dosing device, and to crystallization. In order to improve the operational safety, it is provided according to the method of the invention that a stand-by routine is initiated after termination of a dosing process. In the stand-by routine, liquid is dispensed via a dosing orifice of the dosing device. The dispensing step is repeated after a predetermined period of time.

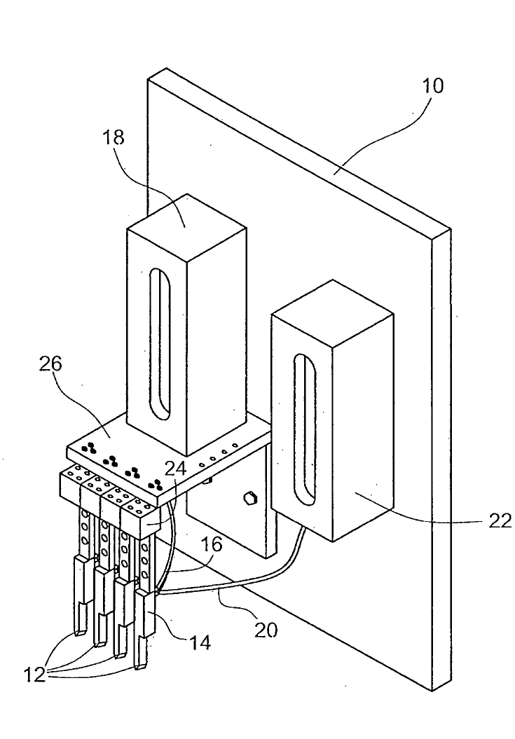

The invention relates to a method for improving the operational safety of dosing devices for chemical and/or biological liquids.

In modern testing methods, chemical and/or biological liquids provided for testing are supplied, by means of automatic dosing devices, e.g. to sample supports. Using suitable dosing devices, the corresponding sample liquids will be either dispensed or pipetted. In case of dispensing, the dosing device comprises a supply container accommodating the sample liquid to be dispensed. The supply of the required quantity of sample liquid to a sample support is performed, e.g. by use of a micropump, via a dispensing tip. In case of pipetting, the sample liquid is first sucked into the pipette by a pipetting tip and a micropump connected thereto, and subsequently the sample liquid is dispensed onto the sample support. For this purpose, automatic pipetting devices have a process liquid provided within the pipetting device, and the receiving and dispensing of the sample liquid is carried out by corresponding reciprocating movements of the process liquid.

Automatic dosing devices are used particularly in high-throughput screening. High-throughput screening processes are used for testing a large number of chemical and/or biological samples in rapid chronological succession. In high-throughput screening, the chemical and/or biological sample liquids are filled e.g. into deepened portions (wells) of titration plates. Known titration plates comprise e.g. 1536 or 2080 wells. Depending on the respective design, the wells have a volume of less than 20 μl, particularly less than 5 μl. Thus, there will be involved extremely small quantities of sample liquid which have to be supplied exactly to a respective well. The supplying of sample liquid is performed e.g. by dispensing microdroplets by means of the dosing device. For this purpose, known dosing devices are provided e.g. with electronically controlled micropumps. For generating suitably small droplets, of which the volume can be smaller than 1 nl and particularly smaller than 0.5 nl, the channel of the pipetting or dosing device has a diameter of 10-100 μm and preferably 40-60 μm.

After termination of the dosing process, which can encompass e.g. the filling of several titration plates, the dosing device will frequently not be required anymore over a longer period of time. Already after a standstill period of 15 minutes or less, depending on the sample or process liquid used, an outgassing of the liquid may occur. This causes a development of small gas bubbles internally of the dosing device. These bubbles will increase over time. Further, extended standstill periods may result in crystallization or sedimentation of particles or components contained in the sample and/or process liquid. These can likewise increase over time. Such gas inclusions and/or crystallizations or sedimentations may result in malfunction or clogging of the dosing device. Thus, prior to using the dosing device for a new dosing process, this device must always be cleansed. Such a cleansing process in which both the gas inclusions and the crystallizations or sedimentations must be completely removed, is massively time-consuming. Further, such cleansing processes cannot be performed automatically since it has to be verified by user intervention that all depositions or gas inclusions have been removed.

Even small gas inclusions or slight crystallizations or depositions may cause an impairment of an automated dosing process. Particularly in high-throughput screening, an exact quantity of sample liquid has to be supplied to each well of a sample support. The quantity of liquid dispensed by a dosing device is determined by the number of drops supplied to a well. Thus, the drop volume has to remain constant and has to be known during the whole dosing process. Already small inclusions of air as well as slight depositions within the dosing device will adulterate the drop volume. This entails the effect that, during the next dosing process, the volume of sample liquid supplied to the wells of the sample support will be too small or too large. Thus, it is required that the drop volume be newly determined each time before a new dosing process is carried out. The determination of the drop volume is very time-consuming. It has to be performed manually by the user.

It is an object of the invention to improve the operational safety of dosing devices, and particularly to reduce the danger of outgassing, crystallization and depositions in dosing devices and/or the like during standstill times.

The above object is achieved by a method according to claim 1.

In the inventive method for improving the operational safety of dosing devices for chemical and/or biological liquids, a stand-by routine is initiated after termination of a dosing process. A dosing process is understood as the filing of wells of one or a plurality of titration plates with sample liquid, e.g. in high-throughput screening. The invention provides that afterwards, within the stand-by routine, liquid is dispensed through a dosing orifice of the dosing device. If the dosing device is e.g. a dispensing or pipetting device, the dispensing of the liquid is performed through the orifices of the pipetting or dispensing tip. According to the invention, the dispensing of liquid is repeated after a predetermined period of time. Preferably, in the invention, such repeated dispensing of liquid is performed during the whole standstill period at regular or irregular intervals.

Thus, in the method of the invention, it is provided that during the standstill periods of the dosing device, a certain amount of liquid will be dispensed by the dosing device from time to time. By the dispensing of liquid and the associated movement of the liquid, an outgassing of the liquid as well as an intrusion of gas through the dosing orifice is prevented or at least considerably reduced. At the same time, the movement of the liquid prevents or considerably reduces a crystallizing of the liquid or a deposition of particles or components. As a result, the dosing device will be directly ready for use even after extended standstill periods which can last up to several hours. The need for a bothersome cleansing of the dosing device is obviated. Particularly, since the inventive method precludes disturbing gas inclusions or depositions, it is not necessary anymore to newly determine the drop volume prior to starting a new dosing process.

The liquid is preferably dispensed in the form of droplets. Thus, also during the stand-by routine, the generated droplets will advantageously have the preset drop volume. Thereby, it is safeguarded with increased reliability that the drop volume does not undergo changes during the stand-by routine. In the process, a plurality of droplets, particularly more than twenty, preferably more than fifty and most preferably more than eighty droplets, are dispensed per liquid dispensing step. The dispensing of a plurality of droplets safeguards a sufficient movement of the liquid within the dosing device. Further, gases which between two liquid dispensing steps may have intruded into the device through the dosing orifice, will be reliably discharged again.

Further, it is rendered possible, in a liquid dispensing step, to have a predetermined quantity of liquid dispensed continuously. By the continuous dispensing of a predetermined quantity of liquid, the dosing device is subjected to a rinsing process. The rinsing will have the effect that e.g. smaller depositions are detached or washed out from the dosing device. The quantity of liquid dispensed by the dosing device in a rinsing step is preferably in the range from 1 μl to 1 ml. Further, during the rinsing, the pressure is distinctly higher than during the dispensing of droplets.

According to an especially preferred embodiment, there is performed a combination of droplet dispensing steps, i.e. liquid dispensing steps in which droplets are dispensed, and rinsing steps, i.e. liquid dispensing steps in which a continuous dispensing of liquid is carried out over a predetermined period of time. In this manner, both of the two above described advantages are realized. Preferably, between two rinsing steps, a plurality of droplet dispensing steps are provided. This has the advantage that the overall quantity of liquid required during a stand-by routine under maintenance of the operational safety is merely small, since only a small quantity of liquid is dispensed in the droplet dispensing step. By the provision of rinsing steps, it is further guaranteed that depositions and the like which possibly might be generated in spite of the droplet dispensing steps, will be washed out. Preferably, more than ten, particularly more than twenty and most preferably more than fifty droplet dispensing steps are performed.

Tests have shown that a time interval from 20 to 80 seconds, particularly from 30 to 50 seconds, between two successive liquid dispensing steps, particularly droplet dispensing steps, is advantageous. Rinsing steps are preferably performed every 30 to 90 minutes. In this regard, the optimum time interval between successive liquid dispensing steps depends on the liquid contained in the dosing device and also, e.g., on the order of rinsing steps and droplet dispensing steps. Further, in this regard, influential factors such as ambient temperature, humidity of the ambient air and the like can be considered.

Preferably, if the dosing device is a dispensing device, the liquid dispensed in the droplet dispensing step is a sample liquid. This offers the advantage that the stand-by routine can be interrupted at any desired time and that the wells or the like can be filled immediately after the interruption. If the droplet dispensing step is performed with a different liquid, e.g. a cleansing liquid, it has to be verified prior the start of the next dosing process that the dosing device has sample liquid and no cleansing liquid arranged therein near the dispensing orifice. Nonetheless, since sample liquids are very expensive, it may be of advantage to use a cleansing liquid or the like during the stand-by routine.

The rinsing liquid will preferably be not the sample liquid but a cleansing liquid or the like since the sample liquid is expensive and the rinsing steps involve the dispensing of a relatively large quantity of liquid through the dosing device. In pipetting devices, preferred use is made of a process liquid for carrying out a rinsing step. A process liquid is used particularly in pipetting devices. This is a liquid contained internally of the pipetting device and is utilized for generating a vacuum, e.g. by means of a pump, for sectional intake of sample liquid. The use of a process liquid in pipetting devices is advantageous in that only a small quantity of sample liquid has to be sucked in. Thus, it is not required to fill the whole pipetting device with sample liquid. Thus, for instance, there will always exist process liquid in the region of the micropump. The process liquid is merely sucked into the pipetting tip and dispensed again therefrom.

The triggering of the stand-by routine can be performed e.g. by a user who after termination of the dosing process will initiate the stand-by routine via a control unit. Preferably, the stand-by routine is triggered automatically. The triggering of the stand-by routine preferably takes place upon lapse of a predetermined period of time after termination of the dosing process. The length of this time period is preferably from 30 to 60 seconds. By an automated triggering of the stand-by routine, the start of the stand-by routine is advantageously independent from the user and thus cannot be forgotten.

A preferred embodiment of invention will be explained in greater detail hereunder with the reference to the accompanying drawing.

The FIGURE shows a view of a dispensing device for the filling of titration plates.

In the FIGURE, a device for performing the method of the invention is exemplified by a dispensing device. The dispensing device is connected, by means of a mounting plate 10, to a holding device provided for displacement of the dispensing device so that dispensing tips 12 are movable into positions located above the wells of a titration plate. The dispensing tips 12 which have a dosing orifice formed therein are connected to a micropump 14 for dispensing sample liquid from the dispensing tips 12. Each micropump 14 is connected via a tube 16 to a supply container 18. The supply container 18 has sample liquid provided therein. Further, the micropumps 14 are connected, respectively via a tube 20, to a supply container 22 with rinsing liquid.

Each of the micropumps 14 is supported by an adjustment means 24 and is connected, through the adjustment means 24, to a mounting support 26. Mounting support 26 is fastened to a mounting plate 10.

During a dosing process, sample liquid is pumped by means of the micropumps 14 from the supply container 18 towards the dispensing tips 12 and is dispensed in drop-wise fashion via the dosing orifices of the dispensing tips into wells of a titration plate. After dispensing a predetermined number of drops, the dispensing device or the titration plate will be displaced, and the next wells will be filled.

Once the stand-by routine according to the invention is initiated by the user or—due to lapse of time—automatically, it is possible that e.g. the following stand-by routine is performed under maintenance of the operational safety:

Immediately after the initiating of the stand-by routine, a rinsing step is carried out. In this step, a valve provided on the micropump 14 is switched by a control unit to the effect that the micropump 14 can suck only rinsing liquid from the supply container 22 via tube 20. The rinsing process is carried out for a period of about five minutes. In the process, liquid is continuously dispensed via dispensing tip 12 into a receptacle.

After lapse of a period of e.g. 30 seconds upon termination of the rinsing process, a droplet dispensing step is performed. The step will last from about 25 to about 30 milliseconds. During this step, micropump 14 is operated with a frequency of about 3500 Hz, causing 100 drops to be dispensed.

After a further standstill period of about 30 seconds, a further droplet dispensing step is performed which corresponds to the first droplet dispensing step. At intervals of 30 seconds, a predetermined number of droplet dispensing steps is performed.

After e.g. 240 droplet dispensing steps, a rinsing step will be performed again.

These method steps are repeated throughout the stand-by routine. If desired, the time intervals between the individual rinsing steps are shortened, preferably continuously with advancing stand-by time.

For economical reasons, stand-by periods of more than 72 hours are normally not useful.

1. A method for improving the operational safety of dosing devices for chemical and/or biological liquids, wherein
a stand-by routine is initiated upon termination of a dosing process, the stand-by routine comprising the following steps:
dispensing liquid through a dosing orifice of the dosing device, and
repeating the dispensing step after a predetermined period of time.

2. The method according to claim 1 wherein the liquid is dispensed in the form of droplets.

3. The method according to claim 1 or 2 wherein, in a liquid dispensing step, a plurality of droplets, particularly more than twenty, preferably more than fifty and most preferably more than eighty, is dispensed.

4. The method according to claim 1 wherein, in a liquid dispensing step, a predetermined quantity of liquid, particularly from 1 μl to 1 ml, is continuously dispensed for rinsing the dosing device.

5. The method according to any one of claims 1-4 wherein, during a stand-by routine comprising a plurality of liquid dispensing steps, part of the liquid dispensing steps include a droplet dispensing step and part of the liquid dispensing steps include a rinsing step.

6. The method according to claim 5 wherein, between two rinsing steps, a plurality of droplet dispensing steps, preferably more than ten and particularly more than twenty droplet dispensing steps, are performed.

7. The method according to any one of claims 1-6 wherein the time interval between two successive dispensing steps is from 20 to 80 seconds, particularly from 30 to 50 seconds.

8. The method according to any one of claims 1-7 wherein the time interval between two successive dispensing steps is reduced with increased length of the stand-by routine.

9. The method according to any one of claims 1-8 wherein, in the droplet dispensing step, sample liquid is dispensed.

10. The method according to any one of claims 1-9 wherein, in the liquid dispensing step, rinsing liquid is dispensed.

11. The method according to any one of claims 1-10 wherein the stand-by routine is automatically initiated upon lapse of a predetermined period of time of preferably from 30 to 60 seconds after termination of the dosing process.
